(19) United States
(12) Patent Application Publication
(10) Pub. No.: US 2016/0282795 A1
(43) Pub. Date: Sep. 29, 2016

(54) SHEET PROCESSING DEVICE AND IMAGE FORMING SYSTEM

(71) Applicant: FUJI XEROX CO., LTD., Tokyo (JP)

(72) Inventor: Toshimasa SAKAE, Kanagawa (JP)

(73) Assignee: FUJI XEROX CO., LTD., Tokyo (JP)

(21) Appl. No.: 14/852,770

(22) Filed: Sep. 14, 2015

(30) Foreign Application Priority Data
Mar. 27, 2015 (JP) 2015-065515

(51) Int. Cl. G03G 15/00

(52) U.S. Cl. CPC G03G 15/6582

(57) ABSTRACT

A sheet processing device includes a pressing unit that includes a first pressing member and a second pressing member, the first pressing member opposing and pressing a fold of a sheet, the second pressing member nipping the fold, being positioned opposite to the first pressing member, and pressing the fold; a sheet placement unit that is provided below the pressing unit, the sheet being placed on the sheet placement unit; and a moving unit that moves a position of at least one of the first pressing member and the second pressing member of the pressing unit and causes the sheet whose fold has been pressed by the pressing unit to move to the sheet placement unit by self weight of the sheet.

### CROSS-REFERENCE TO RELATED APPLICATIONS

This application is based on and claims priority under 35 USC 119 from Japanese Patent Application No. 2015-065515 filed Mar. 27, 2015.

### BACKGROUND

1. Technical Field

The present invention relates to a sheet processing device and an image forming system.

### SUMMARY

According to an aspect of the invention, there is provided a sheet processing device including a pressing unit that includes a first pressing member and a second pressing member, the first pressing member opposing and pressing a fold of a sheet, the second pressing member nipping the fold, being positioned opposite to the first pressing member, and pressing the fold; a sheet placement unit that is provided below the pressing unit, the sheet being placed on the sheet placement unit; and a moving unit that moves a position of at least one of the first pressing member and the second pressing member of the pressing unit and causes the sheet whose fold has been pressed by the pressing unit to move to the sheet placement unit by self weight of the sheet.

### BRIEF DESCRIPTION OF THE DRAWINGS

An exemplary embodiment of the present invention will be described in detail based on the following figures, wherein:

FIG. 1 is an overall view of an image forming system according to an exemplary embodiment;

FIG. 2 is an explanatory view of a post-processing apparatus according to the exemplary embodiment;

FIG. 3 is an explanatory view of a saddle-stitching bookbinding functional section according to the exemplary embodiment;

FIG. 4 is an explanatory view of a structure of the vicinity of a folding mechanism;

FIG. 5 is an overall perspective view of a pressing roller unit according to the exemplary embodiment;

FIG. 6 is a development of an outer peripheral surface of a first pressing roller;

FIGS. 7A to 7D each illustrate a pressing process performed on a fold by the pressing roller unit;

FIGS. 8A and 8B each illustrate the pressing process performed on the fold by the pressing roller unit;

FIG. 9 is an explanatory view of a mechanism for realizing a pressing operation and a moving operation of the pressing roller unit;

FIGS. 10A and 10B are each an explanatory view of the pressing operation of the pressing roller unit;

FIG. 11 is an explanatory view of the pressing operation of the pressing roller unit;

FIGS. 12A and 12B are each an explanatory view of a retreating operation of the pressing roller unit;

FIGS. 13A to 13C are each a conceptual view of a pressing roller unit according to a first modification;

FIGS. 14A and 14B are each a conceptual view of a pressing roller unit according to a second modification;

FIGS. 15A and 15B are each a conceptual view of a pressing roller unit according to a third modification;

FIGS. 16A and 16B are each a conceptual view of a pressing roller unit according to a fourth modification;

FIGS. 17A to 17C are each a conceptual view of a pressing roller unit according to a fifth modification; and

FIGS. 18A to 18C are each a conceptual view of a pressing roller unit according to a sixth modification.

### DETAILED DESCRIPTION

An exemplary embodiment of the present invention is hereunder described with reference to the attached drawings.

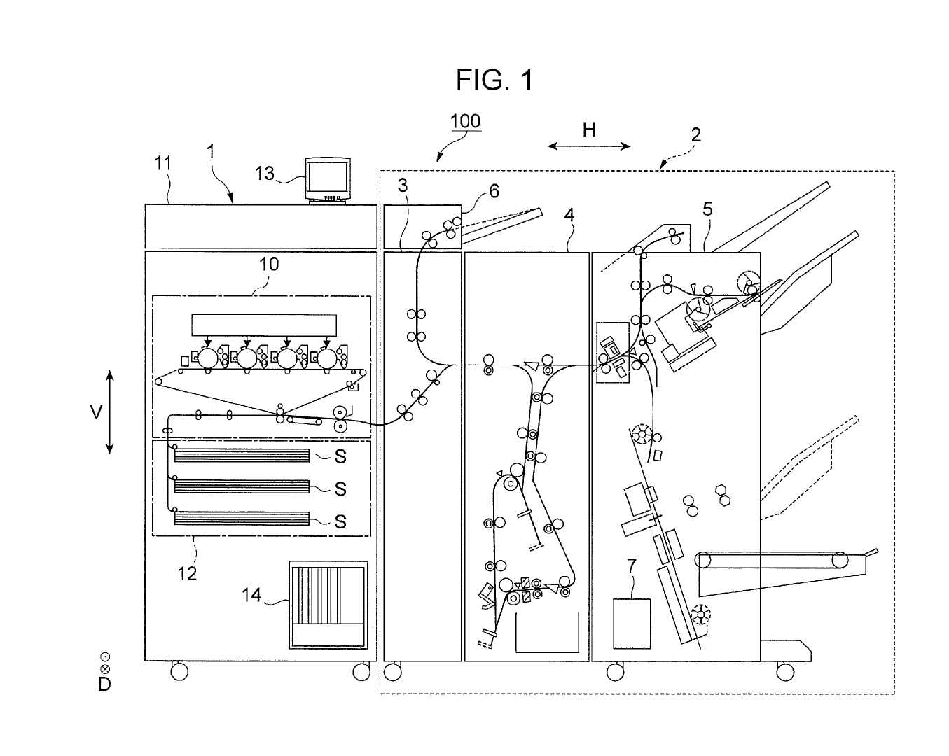

FIG. 1 is an overall view of an image forming system 100 according to an exemplary embodiment.

As shown in FIG. 1, the image forming system 100 includes an image forming apparatus 1, such as a printer or a copying machine, that forms a color image by, for example, an electrophotographic system, and a post-processing apparatus 2 that performs post-processing on a sheet S on which the image has been formed by the image forming apparatus 1.

In the exemplary embodiment, a direction towards a near side and a direction towards a far side of the image forming system 100 shown in FIG. 1 in the plane of FIG. 1 are each described as a front-back direction D. A direction towards an upper side and a direction towards a lower side of the image forming system 100 shown in FIG. 1 in the plane of FIG. 1 are each described as an up-down direction V. A direction towards the left and a direction towards the right of the image forming system 100 in the plane of FIG. 1 are each described as a left-right direction H.

The image forming apparatus 1 includes an image forming unit 10 that forms images on the basis of corresponding pieces of color image data, an image reading unit 11 that reads an image from an original and provides image data acquired by reading, a sheet supplying unit 12 that supplies sheets S to the image forming unit 10, a general user interface 13 that accepts an operation input from a user and that provides information to the user, and a main controller 14 that controls the operation of the entire image forming system 100.

The post-processing apparatus 2 includes a transport unit 3 that receives and transports a sheet S on which images have been formed from the image forming apparatus 1, a folding unit 4 (exemplary folding mechanism) that folds the sheet S sent in from the transport unit 3, a finisher unit 5 (exemplary sheet processing device) that performs a finishing operation on the sheet S that has passed through the folding unit 4, and an interposer 6 that supplies an inserting sheet used as, for example, the cover of a booklet. The post-processing apparatus 2 further includes a sheet processing controller 7 that controls each functional section of the post-processing apparatus 2.

Although, in the exemplary embodiment, an exemplary structure in which the sheet processing controller 7 is provided in the post-processing apparatus 2 is described, the sheet processing controller 7 may be provided in the image forming apparatus 1. The main controller 14 may also be provided with the controlling functions of the sheet processing controller 7.

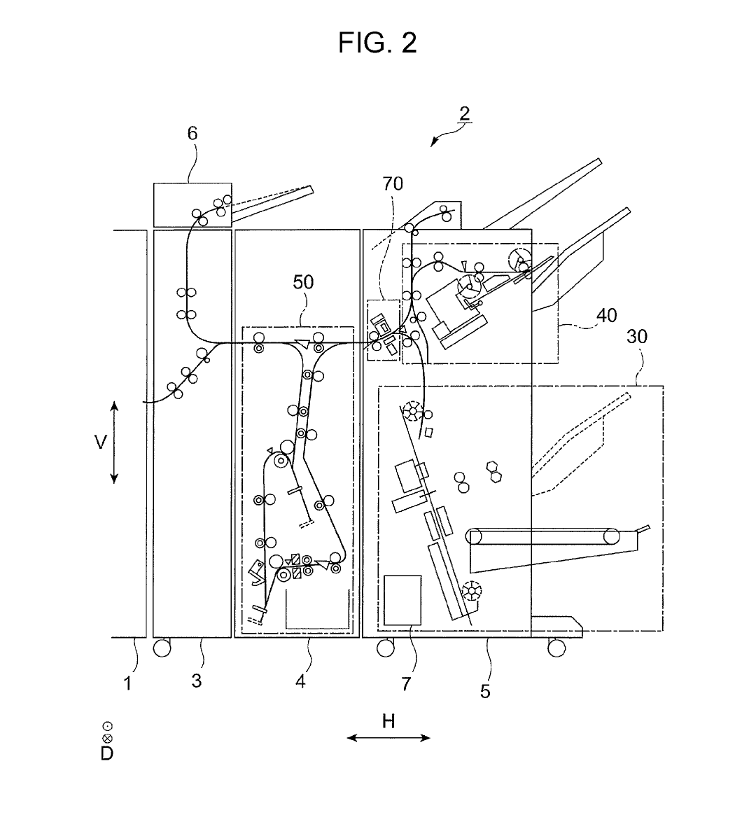

FIG. 2 illustrates the post-processing apparatus 2 according to the exemplary embodiment.

The post-processing apparatus 2 includes the finisher unit 5. The finisher unit 5 includes a punching functional section 70 that punches holes, such as two holes or four holes, in a sheet S, and an end stitching functional section 40 that causes the necessary number of sheets S to accumulate and moves a sheet bundle, to staple (perform end stitching on) an end portion of the sheet bundle.

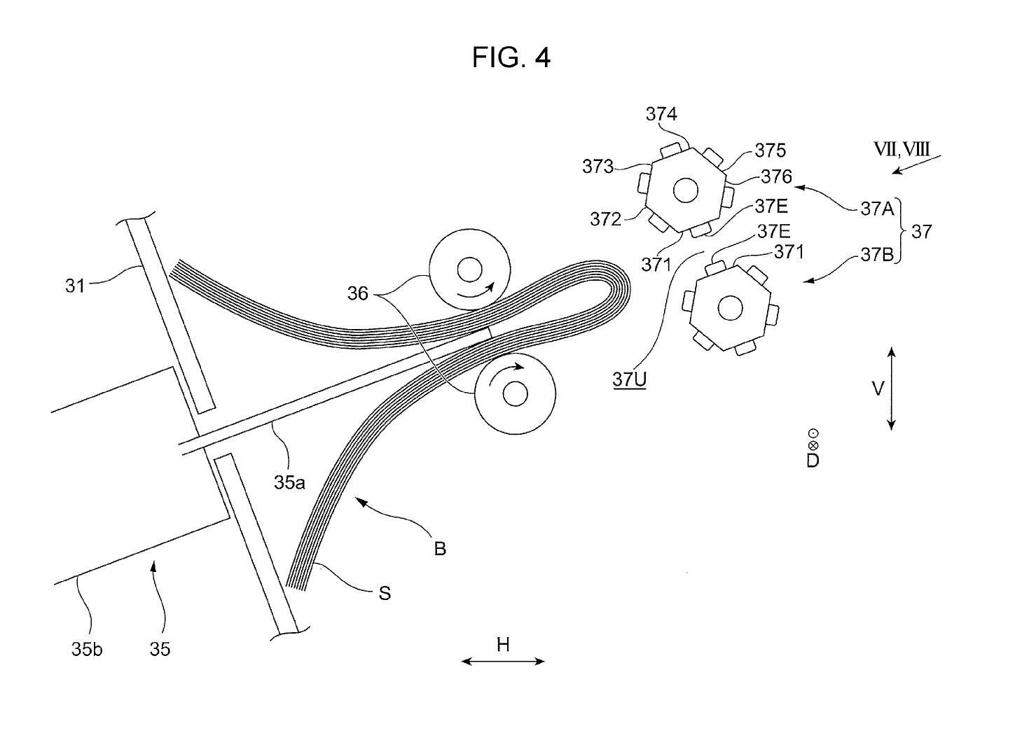

The post-processing apparatus 2 further includes a saddle-stitching bookbinding functional section 30 that causes the necessary number of sheets S to accumulate to form a sheet bundle B (see FIG. 4 described below), and performs a stitching operation (saddle-stitching operation) on a central portion of the sheet bundle B, to form a booklet (bookbinding operation).

The folding unit 4 of the post-processing apparatus 2 includes a folding functional section 50 that performs folding, such as C folding or Z folding, on a sheet S.

### Structure of Saddle-Stitching Bookbinding Functional Section 30

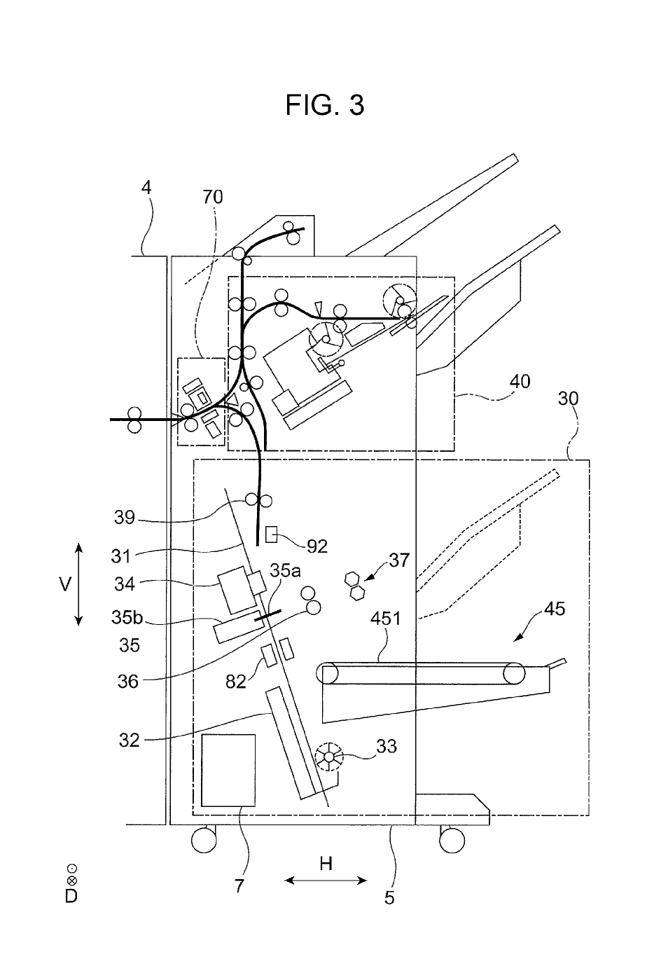

FIG. 3 illustrates the saddle-stitching bookbinding functional section 30 according to the exemplary embodiment.

FIG. 4 is an explanatory view of a structure of the vicinity of a folding mechanism 35.

The saddle-stitching bookbinding functional section 30 includes a compiling member 31, send-in rollers 39, and an end guide 32. The compiling member 31 is a plate-shaped member that forms a sheet bundle by causing a predetermined number of sheets S on which images have been formed to accumulate. The send-in rollers 39 send in the sheets S one sheet at a time to the compiling member 31. The end guide 32 supports the sheet bundle on the compiling member 31 from beneath the sheet bundle. The end guide 32 is movable along the compiling member 31.

The saddle-stitching bookbinding functional section 30 also includes a sheet-aligning paddle 33, a sheet width adjusting member 34, and a stapler 82. The sheet aligning paddle 33 urges the sheets S accumulated on the compiling member 31 towards the end guide 32, and aligns end portions of the sheets S. The sheet width adjusting member 34 aligns the sheets S accumulated on the compiling member 31 in a sheet-S width direction. The stapler 82 staples the sheet bundle on the compiling member 31 by causing staples (not shown) to be driven therethrough.

The saddle-stitching bookbinding functional section 30 further includes the folding mechanism 35 that folds the stitched sheet bundle. The folding mechanism 35 includes a fold knife 35a and an advancing mechanism 35b. The advancing mechanism 35b includes, for example, a motor, and causes the fold knife 35a to advance towards an accommodation-surface side from a back-surface side of the compiling member 31.

The saddle-stitching bookbinding functional section 30 further includes insertion rollers 36 (exemplary transporting members), a pressing roller unit 37, a sheet placement unit 45, and a sheet sensor 92. The insertion rollers 36 include a pair of rollers in which the sheet bundle B on which the folding has been started by the fold knife 35a is inserted. The pressing roller unit 37 presses a fold of the sheet bundle B that has passed through the insertion rollers 36. The sheet placement unit 45 is provided downstream from the pressing roller unit 37. The sheet bundle B that has been bound into a booklet is placed on the sheet placement unit 45. The sheet sensor 92 detects the sheets S that are sent into the compiling member 31 by the send-in rollers 39.

As shown in FIG. 4, the insertion rollers 36 transport the sheet bundle B, and cause the fold of the sheet bundle B to be positioned at a pressing position 37U corresponding to a position where the fold is pressed at the pressing roller unit 37. Therefore, in the exemplary embodiment, the distance between the insertion rollers 36 and the pressing roller unit 37 is at least smaller than the width of the sheet bundle B (width in a transport direction). In the exemplary embodiment, the insertion rollers 36 are such that a predetermined amount of the fold (end portion at a downstream side in the transport direction of the sheet bundle B) of the sheet bundle B is capable of being sent downstream with respect to the pressing position 37U.

As shown in FIG. 3, the pressing roller unit 37 according to the exemplary embodiment is provided downstream from the insertion rollers 36.

In the saddle-stitching bookbinding functional section 30 according to the exemplary embodiment, transporting members, such as dedicated transporting rollers, for taking out the sheet bundle B from the pressing roller unit 37 are not provided downstream from the pressing roller unit 37. That is, special transporting members for transporting the sheet bundle B are not provided in a movement path of the sheet bundle B between the pressing roller unit 37 and the sheet placement unit 45.

The sheet placement unit 45 is provided below the pressing roller unit 37. The sheet placement unit 45 may be provided directly below the pressing roller unit 37 in the up-down direction V, or may be provided at a location that is separated from the location that is directly below the pressing roller unit 37 by a predetermined distance in the left-right direction H. As described below, a location that is separated from a location that is directly below the pressing roller unit 37 by a predetermined distance in the left-right direction H may be set within a range that allows at least a portion of the sheet bundle B to be contactable when the position of at least one of a first pressing roller 37A and a second pressing roller 37B of the pressing roller unit 37 is moved and the sheet bundle B either falls or moves downward.

The sheet placement unit 45 includes a transporting belt 451. The sheet placement unit 45 transports the sheet bundle whose fold has been pressed by the pressing roller unit 37 up to a predetermined position. For example, when the pressing roller unit 37 is disposed at a relatively outer side in the apparatus or when the sheet placement unit 45 is tilted towards an outer portion of the apparatus from an inner portion of the apparatus and the sheet bundle B slides and moves by self weight thereof, the transporting belt is not required.

### Structure of Vicinity of Folding Mechanism 35

In the exemplary embodiment, as shown in FIG. 4, the folding mechanism 35 that folds the stitched sheet bundle B is provided. The folding mechanism 35 includes the fold knife 35a and the advancing mechanism 35b that causes the fold knife 35a to advance towards the sheet bundle B.

Here, in the exemplary embodiment, the fold knife 35a advances such that an end of the fold knife 35a reaches the insertion rollers 36. This causes a fold line to be formed in the sheet bundle B, and a fold line (fold) to be pressed from both sides by the insertion rollers 36.

When sheets are accumulated on the compiling member 31, when saddle-stitching is performed with the stapler 82 (see FIG. 3), or when sheets are transported after the saddle-stitching, the fold knife 35a is positioned behind the compiling member 31. This may prevent interference between a sheet S and the fold knife 35a.

### Overall Structure of Pressing Roller Unit 37

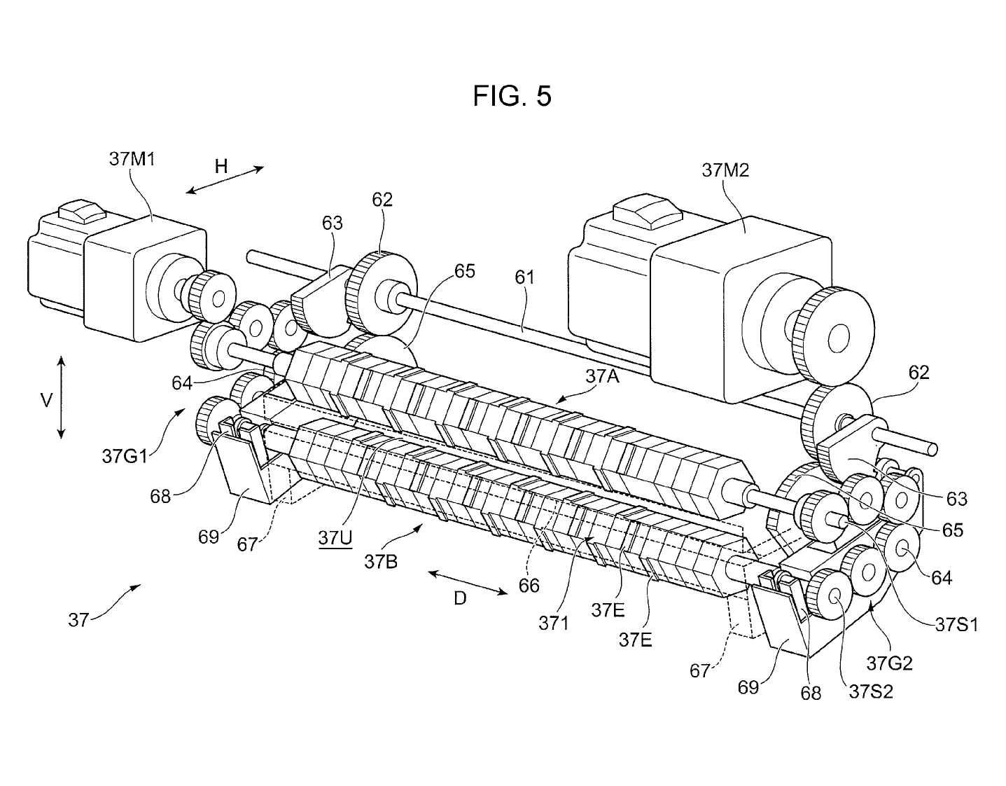

FIG. 5 is an overall perspective view of the pressing roller unit 37 according to the exemplary embodiment.

The pressing roller unit 37 (exemplary pressing unit) includes the first pressing roller 37A (exemplary first pressing member) and the second pressing roller 37B (exemplary second pressing member), which are a pair of rollers that press a fold of a sheet bundle B. The pressing roller unit 37 according to the exemplary embodiment performs a rotating operation in which the first pressing roller 37A and the second pressing roller 37B are each rotated around a rotation axis thereof for pressing the fold of the sheet bundle B, a pressing operation for pressing the fold of the sheet bundle B by the second pressing roller 37B and the first pressing roller 37A, and a retreating operation for moving the position of at least one of the first pressing roller 37A and the second pressing roller 37B and causing the at least one of the first pressing roller 37A and the second pressing roller 37B to retreat from a pressing position 37U.

First, a mechanism for realizing the rotating operation of the first pressing roller 37A and the second pressing roller 37B and a pressing process for pressing a fold of a sheet bundle B by the rotating operation and the pressing operation are described in detail.

A mechanism for realizing the pressing operation and a mechanism for realizing the retreating operation are described later.

### Mechanism for Realizing Rotating Operation of Pressing Roller Unit 37

As shown in FIG. 5, the pressing roller unit 37 includes a first driving motor 37M1, a first gear train 37G1, and a second gear train 37G2. The first gear train 37G1 is connected to the first driving motor 37M1.

The first pressing roller 37A and the second pressing roller 37B are provided such that their axial directions extend along the front-back directions. The first pressing roller 37A is provided so as to be rotatable around a first press rotation shaft 37S1 as a rotation center. The first press rotation shaft 37S1 is rotatably supported by a supporting member (not shown) secured to an apparatus body.

The second pressing roller 37B is provided so as to be rotatable around second press rotation shafts 37S2 as rotation centers. The second press rotation shafts 37S2 are rotatably supported by press supporting members 68 (described later).

The first gear train 37G1 is provided on one side of the first press rotation shaft 37S1 in the axial direction. The first gear train 37G1 is connected to the first press rotation shaft 37S1 and the second press rotation shafts 37S2.

The second gear train 37G2 is provided on the other side of the first press rotation shaft 37S1 in the axial direction. The second gear train 37G2 is connected to the first press rotation shaft 37S1 and the second press rotation shafts 37S2.

The first driving motor 37M1 rotates the first press rotation shaft 37S1 and the second press rotation shafts 37S2 via the first gear train 37G1. In the exemplary embodiment, on the other side in the axial direction, the second gear train 37G2 is connected to the first press rotation shaft 37S1 and the second press rotation shafts 37S2. Therefore, the first press rotation shaft 37S1 and the second press rotation shafts 37S2 according to the exemplary embodiment receive rotation force in synchronism in the axial direction.

### Structure of First Pressing Roller 37A

The first pressing roller 37A is hexagonal in cross section. The first pressing roller 37A also includes opposing surfaces (exemplary opposing portions) 371 that oppose a fold of a sheet bundle B. In the exemplary embodiment, the opposing surfaces 371 have protrusions 37E.

Further, in the exemplary embodiment, as shown in FIG. 4, the first pressing roller 37A is such that an opposing surface 371 is switched to another opposing surface 371 due to rotation of the first pressing roller 37A. More specifically, in the exemplary embodiment, since the first pressing roller 37A is hexagonal in cross section, six opposing surfaces 371 to 376 (hereunder referred to as “first opposing surface 371 to sixth opposing surface 376”) are provided, each opposing surface being provided with protrusions 37E.

In the description below, when the first opposing surface 371 to the sixth opposing surface 376 do not need to be particularly distinguished, they are collectively called “opposing surfaces 371”.

The second pressing roller 37B has the same structure as the first pressing roller 37A. That is, the second pressing roller 37B is hexagonal in cross section, and includes six opposing surfaces 371 (first opposing surface 371 to sixth opposing surface 376). The six opposing surfaces of the second pressing roller 37B are each provided with protrusions 37E. The second pressing roller 37B according to the exemplary embodiment is disposed below the first pressing roller 37A in the up-down direction V.

As shown in FIG. 5, the second pressing roller 37B is disposed substantially parallel with the first pressing roller 37A. The second pressing roller 37B rotates around a rotation shaft along the axial direction of the first pressing roller 37A, and in a direction opposite to that of the first pressing roller 37A.

The second pressing roller 37B nips a fold of a sheet bundle B, is positioned opposite to the first pressing roller 37A, and presses the fold.

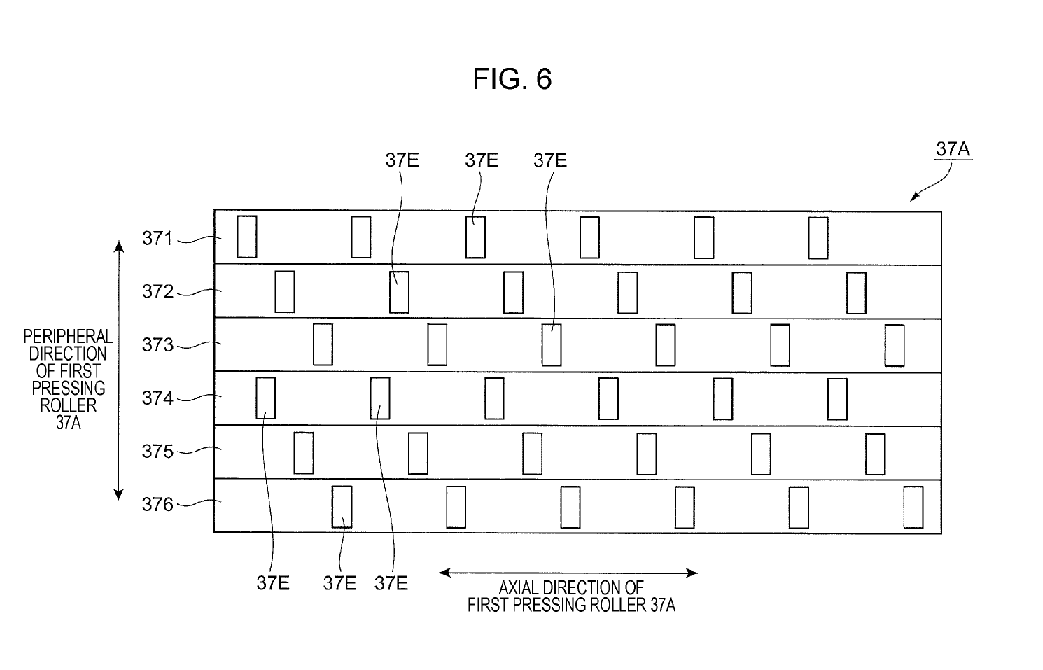

FIG. 6 is a development of an outer peripheral surface of the first pressing roller 37A.

As described above, in the exemplary embodiment, the first opposing surface 371 to the sixth opposing surface 376 are provided. In the development shown in FIG. 6, the first opposing surface 371 to the sixth opposing surface 376 are disposed side by side in the up-down directions.

The first opposing surface 371 to the sixth opposing surface 376 are each provided with multiple protrusions 37E. In the axial direction of the first pressing roller 37A, the positional arrangements of the protrusions 37E on the corresponding opposing surfaces do not correspond with each other. In the exemplary embodiment, when the positional arrangements in the axial direction of all of the protrusions 37E that are formed on the first opposing surface 371 to the sixth opposing surface 376 correspond with each other, the protrusions 37E in the axial direction on the first opposing surface 371 to the sixth opposing surface 376 are disposed without gaps. The protrusions 37E that are disposed side by side in rows are made to correspond with a fold of a sheet bundle B.

### Pressing Process of Pressing Roller Unit 37

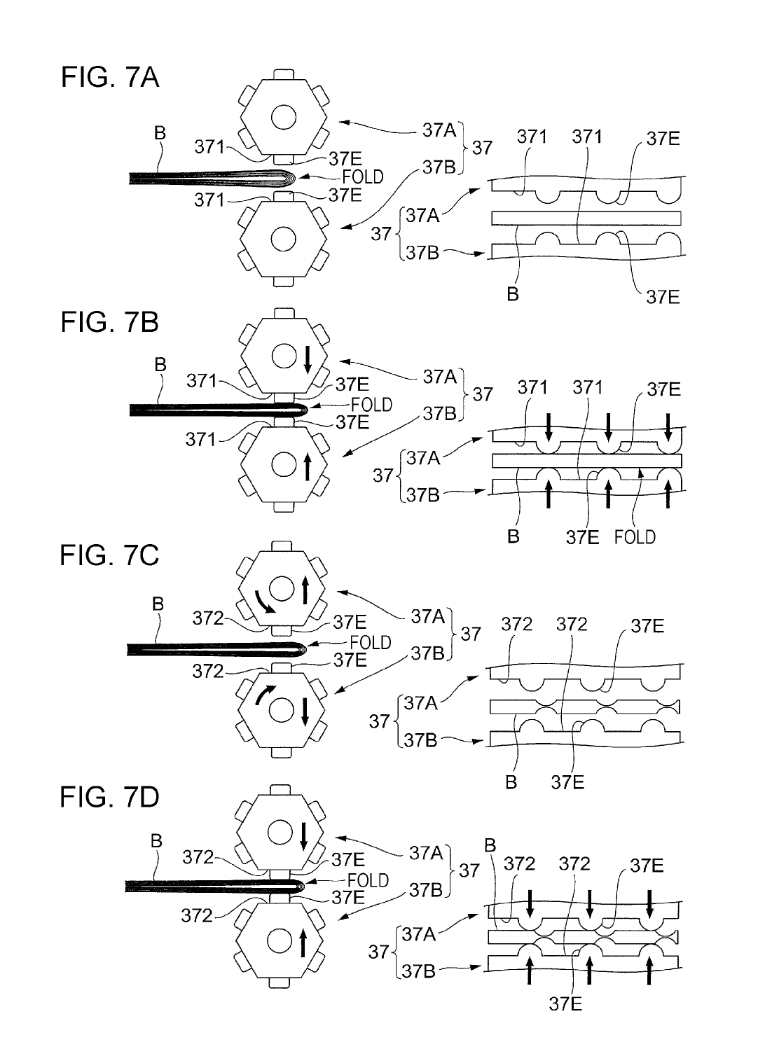

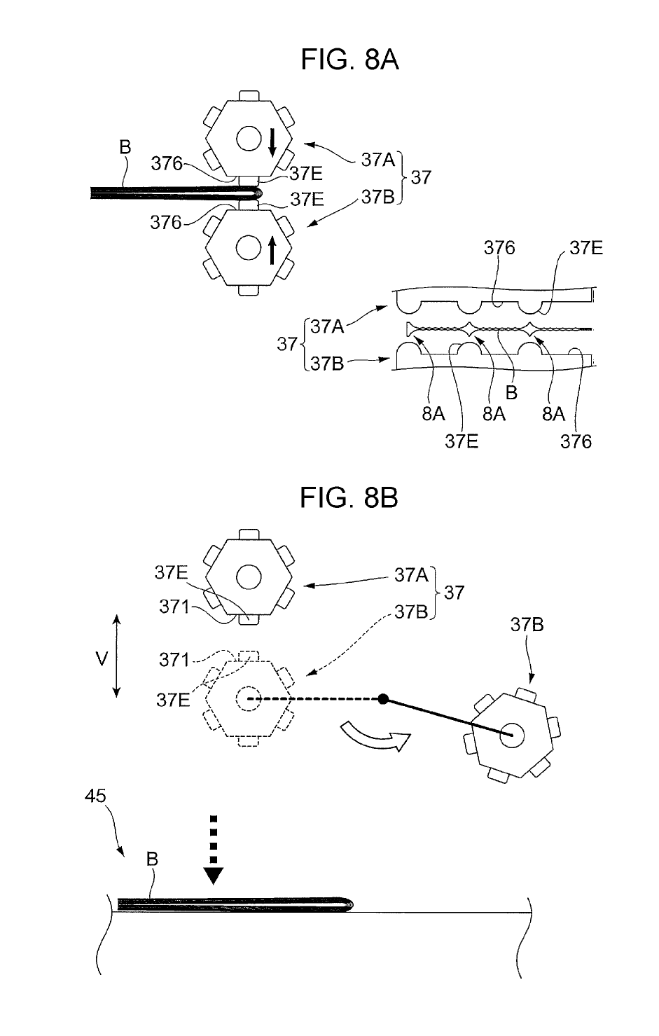

FIGS. 7A to 7D and FIGS. 8A and 8B each illustrate the pressing process performed on a fold by the pressing roller unit 37.

In each of FIGS. 7A to 8B, a case in which the pressing roller unit 37 and a sheet bundle B are viewed from arrow VII or arrow VIII in FIG. 4 is also shown.

Here, in the exemplary embodiment, when the insertion rollers 36 (see FIG. 3) transport a sheet bundle B to the pressing roller unit 37, and a fold of the sheet bundle B reaches the pressing roller unit 37, the transport of the sheet bundle B by the insertion rollers 36 is temporarily stopped. At this time, as shown in FIG. 7A, in the pressing roller unit 37, the first pressing roller 37A and the second pressing roller 37B are separated from each other.

Next, in the exemplary embodiment, as shown in FIG. 7B, the first pressing roller 37A and the second pressing roller 37B advance towards the fold, and press the fold. More specifically, the protrusions 37E provided on the first opposing surface 371 of the first pressing roller 37A and the protrusions 37E provided on the first opposing surface 371 of the second pressing roller 37B on the other side and nip the fold. This causes the fold to be pressed by the two sets of protrusions 37E. By this, the fold is flattened such that swelling of the sheet bundle B is reduced.

Next, in the exemplary embodiment, as shown in FIG. 7C, the first pressing roller 37A and the second pressing roller 37B retreat from the fold, and the first pressing roller 37A and the second pressing roller 37B rotate by ⅙ of a rotation. This causes the second opposing surface 372 of the first pressing roller 37A and the second opposing surface 372 of the second pressing roller 37B to oppose the fold.

Then, as shown in FIG. 7D, the first pressing roller 37A and the second pressing roller 37B press the fold. More specifically, the protrusions 37E on the second opposing surface 372 of the first pressing roller 37A and the protrusion 37E on the second opposing surface of the second pressing roller 37b press the fold.

Here, in the exemplary embodiment, since, as shown in FIG. 6, the protrusions 37E on the second opposing surface 372 and the protrusions 37E on the first opposing surface 371 are shifted from each other in the axial direction of the pressing roller unit 37, the positions where the second opposing surface 372 presses the fold differ from the positions where the first opposing surface 371 presses the fold.

Thereafter, in the exemplary embodiment, these operations are repeated. The pressing of the fold by the protrusions 37E, the separation of the first pressing roller 37A and the second pressing roller 37B from the fold, the rotation of the first pressing roller 37A and the second pressing roller 37B, and the advancing of the first pressing roller 37A and the second pressing roller 37B towards the fold are repeated.

FIG. 8A illustrates a final stage of the pressing process by the first pressing roller 37A and the second pressing roller 37B. More specifically, FIG. 8A illustrates a state when the fold is pressed by the sixth opposing surfaces 376.

In pressing the fold by the sixth opposing surfaces 376 (the protrusions 37E provided thereat), portions indicated by symbols 8A in FIG. 8A are pressed, so that the fold is placed in a state in which the pressing process has been performed over the entire area of the fold in a longitudinal direction thereof.

Thereafter, in the exemplary embodiment, as shown in FIG. 8B, the second pressing roller 37B moves with respect to the first pressing roller 37A. Then, the second pressing roller 37B moves such that it moves away from a location beneath the sheet bundle B. In this way, the second pressing roller 37B moves to a position that does not interfere with the transport of the sheet bundle B after having pressed the fold of the sheet bundle B. As a result, the sheet bundle B falls by self weight thereof, and is placed on the sheet placement unit 45.

The first pressing roller 37A and the second pressing roller 37B rotate, so that the first opposing surfaces 371 thereof oppose each other. This sets the apparatus in a state in which a pressing process is startable on a next new sheet bundle B.

Here, in the structure according to the exemplary embodiment, the swelling of the sheet bundle B may be suppressed while reducing the size of the apparatus. Here, for example, the swelling of a sheet bundle B may be suppressed by nipping both sides of the sheet bundle B at outer peripheral surfaces of cylindrical roller members. However, in this case, since the fold is pressed by a larger area in a longitudinal direction of the roller members (that is, since the fold is pressed by planar portions, and pressing area becomes large), pressing load per unit area tends to be reduced.

In order to suppress a reduction in such pressing load, for example, it is necessary to increase spring load for the pressing, in which case, for example, it becomes necessary to increase the strength of a frame or the like. This tends to increase the size of the apparatus.

In contrast, in the structure according to the exemplary embodiment, since a sheet bundle B is pressed by using protrusions 37E, it is possible to concentrate pressing load at particular locations of a fold. Accordingly, it is possible to press the fold even if spring load is small. In addition, in this case, it is possible not to use a frame having strength.

Further, in the structure according to the exemplary embodiment, the swelling of a sheet bundle B may be suppressed while suppressing the occurrence of creases in a fold of the sheet bundle B. Here, the swelling of the sheet bundle B is may be suppressed by, for example, further nipping the fold by fold enhancing rollers that perform fold enhancement. However, in this case, the fold enhancing rollers move along the fold while pressing a very narrow area and one location on the fold in a concentrated manner, as a result of which the fold is suddenly flattened. Therefore, fold creases tend to occur in the fold of the sheet bundle B.

In order to suppress the occurrence of such fold creases, for example, it is necessary to reduce deformation of the sheet bundle B that is being pressed, in which case, for example, it is necessary to reduce spring load for the pressing. As a result, the effect of suppressing the swelling of the sheet bundle B tends to be reduced.

In contrast, in the structure according to the exemplary embodiment, even at locations other than the protrusions 37E, the swelling of a sheet bundle B is suppressed to a certain extent from directly thereabove even if a load is not applied. Therefore, even if pressing load is concentrated at particular locations on the fold, the occurrence of fold creases in the fold may be suppressed. In addition, in this case, load is increased to the extent allowed by the strength of a frame or a roller.

As in the exemplary embodiment, in advancing the protrusions 37E whose positions do not correspond with each other towards a fold, it is possible to provide multiple members each having protrusions 37E and successively advancing these members to the fold. In this case, a mechanism that successively replaces these members needs to be provided. Therefore, the apparatus tends to be complicated and large.

In contrast, in the structure according to the exemplary embodiment, protrusions 37E whose positions do not correspond with each other are caused to advance to the fold by only rotating and advancing the pressing roller unit 37. Therefore, as mentioned above, compared to the case in which multiple members are successively advanced, the number of component parts may be reduced. Further, compared to the case in which multiple members are successively advanced, the apparatus may be less complicated and reduced in size.

### Mechanism for Realizing “Pressing Operation” and “Moving Operation” of Pressing Roller Unit 37

Next, a mechanism for realizing the pressing operation of the pressing roller unit 37 and a moving operation of the pressing roller unit 37 is described in detail.

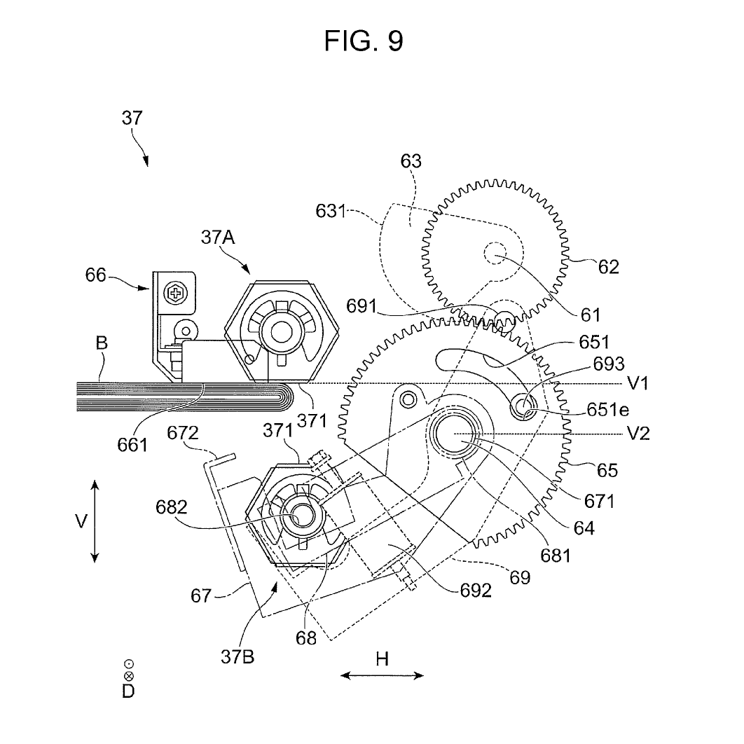

FIG. 9 is an explanatory view of the mechanism for performing a pressing operation of the pressing roller unit 37 and a moving operation of the pressing roller unit 37.

As shown in FIG. 9, the pressing roller unit 37 includes a first rotary shaft 61, first gears 62 that are supported by the first rotary shaft 61, cams 63 that are supported by the first rotary shaft 61, second rotary shafts 64, second gears 65 that are connected to the first gears 62, a sheet holding unit 66, sheet bundle holding arms 67 that are supported by the second rotary shafts 64, the press supporting members 68 that are supported by the second rotary shafts 64, press arms 69 that are rotatably supported by the second rotary shafts 64, and a second driving motor 37M2 (see FIG. 5) that drives the first rotary shaft 61.

In the pressing roller unit 37 according to the exemplary embodiment, for example, the first gears 62, the cams 63, the second rotary shafts 64, the second gears 65, the sheet bundle holding arms 67, the press supporting members 68, and the press arms 69 are provided on respective sides of the first pressing roller 37A in the axial direction thereof (see FIG. 5).

In the exemplary embodiment, the first rotary shaft 61, the first gears 62, the second rotary shafts 64, the second gears 65, the press supporting members 68, and the second driving motor 37M2 function as an exemplary moving unit.

In the exemplary embodiment, the first rotary shaft 61 is provided so as to extend in the axial direction of the first press rotary shaft 37S1 (see FIG. 5). The first rotary shaft 61 is rotatably supported by a supporting member (not shown) that is secured to the apparatus body.

The first gears 62 are secured to the first rotary shaft 61. The first gears 62 are connected to the second driving motor 37M2 and the second gears 65.

Each cam 63 has the shape of a fan, and is secured to the first rotary shaft 61. The cams 63 rotate together with the first rotary shaft 61. Each cam 63 includes a cam surface 631 that contacts a receiving portion 691 (described later) of its corresponding press arm 69. Each cam 63 is such that its cam surface 631 contacts the corresponding receiving portion 691 (described later) by being positioned at a predetermined rotation position.

Each second rotary shaft 64 is provided at an end portion of the first pressing roller 37A in the axial direction thereof. Each second rotary shaft 64 is secured to a supporting member (not shown) that is secured to the apparatus body. As mentioned above, the second rotary shafts 64 are disposed on the respective sides of the first pressing roller 37A in the axial direction thereof. In this way, in the exemplary embodiment, the second rotary shafts 64 are not formed over the entire pressing roller unit 37 in the front-back directions D, and are not formed at a central portion of the pressing roller unit 37 in the front-back directions D. By this, in the exemplary embodiment, the second rotary shafts 64 that are disposed below a sheet bundle B do not interfere with the movement of the sheet bundle B.

In the exemplary embodiment, the second rotary shafts 64 are disposed below the opposing surface 371 (protrusions 37E) of the first pressing roller 37A. More specifically, as shown in FIG. 9, the second rotary shafts 64 are disposed such that a height V2 of each second rotary shaft 64 is situated below a height V1 of an opposing portion 661 (described later) of the sheet holding unit 66. In the exemplary embodiment, when a thickness of a sheet bundle B that is nipped between the first pressing roller 37A and the second pressing roller 37B is a predetermined maximum thickness, it is possible to flatten a fold by a large force.

The second gears 65 are rotatably supported by the second rotary shafts 64. Each second gear 65 includes an arc-shaped groove 651. Each arc-shaped groove 651 includes an end portion 651e in a peripheral direction thereof. Each second gear 65 contacts its corresponding first gear 62.

The sheet holding unit 66 is provided so as to extend along the axial direction of the first press rotary shaft 37S1 (see FIG. 5). The sheet holding unit 66 is supported by a supporting member (not shown) that supports the first press rotary shaft 37S1. The sheet holding unit 66 includes the first opposing portion 661 opposing an upper side of a sheet bundle B. The first opposing portion 661 holds the sheet bundle B at locations differing from a fold of the sheet bundle B when a pressing process is performed on the fold by the first pressing roller 37A and the second pressing roller 37B.

Each sheet bundle holding arm 67 is connected to its corresponding press supporting member 68 via a first torsion spring 671. Each sheet bundle holding arm 67 includes a second opposing portion 672 opposing a lower side of a sheet bundle B. Each second opposing portion 672 is provided at a position that allows it to oppose the corresponding first opposing portion 661. The second opposing portion 672 holds the sheet bundle B at locations differing from a fold of the sheet bundle B when a pressing process is performed on the fold by the first pressing roller 37A and the second pressing roller 37B.

As described above, each press supporting member 68 is connected to its corresponding sheet bundle holding arm 67 through the first torsion spring 671. Each press supporting member 68 is connected to its corresponding press arm 69 via a spring 692. Each press supporting member 68 includes a supporting portion 682 that supports the second press rotary shaft 37S2. The press supporting members 68 rotate the entire second pressing roller 37B around the second rotary shafts 64. In the exemplary embodiment, the press supporting members 68 rotate the second pressing roller 37B by approximately 150 degrees from an opposing position where the second pressing roller 37B is made to oppose the first pressing roller 37A to a retreating position where the second pressing roller 37B is situated at a side opposite to the opposing position with the second rotary shafts 64 being interposed therebetween.

A rotational radius of the second pressing roller 37B defined by the press supporting members 68 is smaller than the distance between the sheet placement unit 45 and each second rotary shaft 64 (see FIG. 8).

Each press arm 69 is rotatably supported by its corresponding second rotary shaft 64. Each press arm 69 is connected to its corresponding second gear 65 via a second torsion spring 681. As mentioned above, each press arm 69 is connected to its corresponding press supporting member 68 via the spring 692. Each press arm 69 includes its corresponding receiving portion 691 with which the cam surface 631 of its corresponding cam 63 contacts, its corresponding spring 692, and a protrusion 693 opposing the arc-shaped groove 651 of its corresponding second gear 65.

Each receiving portion 691 is disposed opposite to its corresponding spring 692 with its corresponding second rotary shaft 64 being interposed therebetween. That is, each press arm 69 is such that, with its corresponding second rotary shaft 64 serving as a fulcrum, a point of action corresponds to its corresponding spring 692, and a point of application corresponds to its corresponding receiving portion 691.

One of the springs 692 in an expansion/contraction direction is secured to its corresponding press arm 69, and the other spring 692 is secured to its corresponding press supporting member 68.

The protrusions 693 protrude in the front-back direction D. Each protrusion 693 is fitted in its corresponding arc-shaped groove 651, and moves relatively along its corresponding arc-shaped groove 651 until it contacts the corresponding end portion 651e.

### Description of Pressing Operation of Pressing Roller Unit

Next, the pressing operation of the pressing roller unit 37 is described.

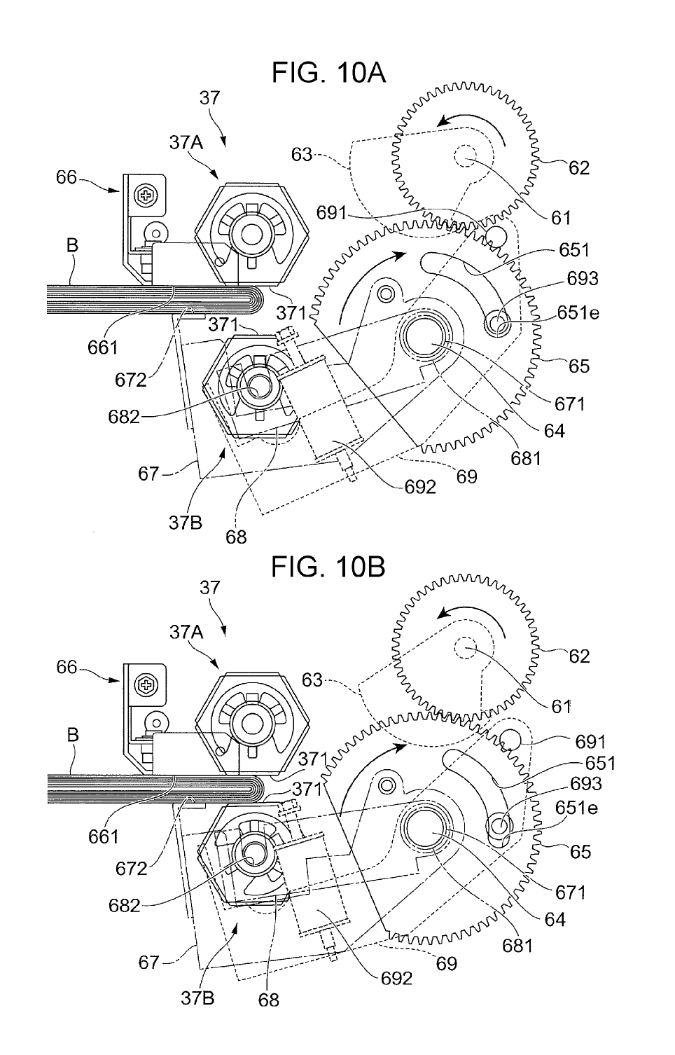

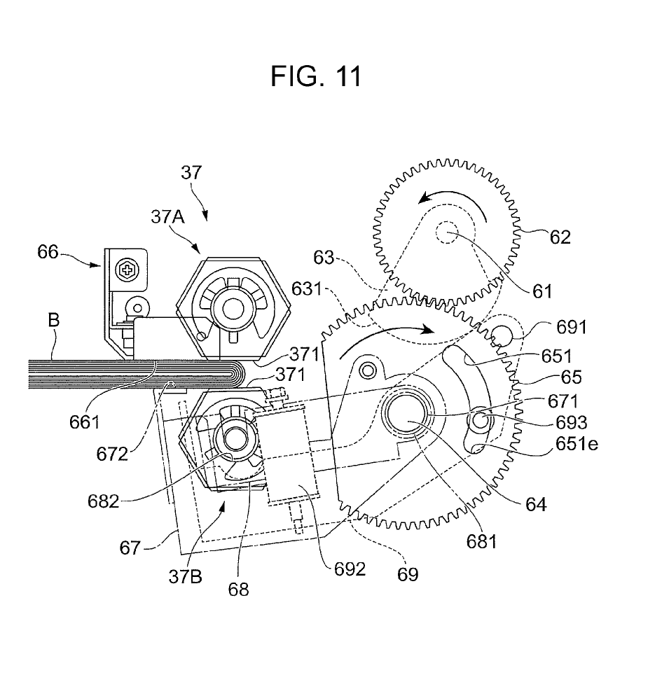

FIGS. 10A, 10B, and 11 are each an explanatory view of the pressing operation of the pressing roller unit 37.

As shown in FIG. 10A, a fold of a sheet bundle B is disposed at a position where the fold of the sheet bundle B opposes the first opposing portion 661 of the sheet holding unit 66 and the opposing surface 371 of the first pressing roller 37A by the insertion rollers 36 (see FIG. 4).

The second driving motor 37M2 (see FIG. 5) rotates the first gears 62 counterclockwise in FIG. 10A, and rotates the second gears 65 clockwise in FIG. 10A. This causes the second gears 65 to rotate the press arms 69 clockwise in FIG. 10A via the second torsion springs 681. Then, this causes the press arms 69 to rotate the press supporting members 68 clockwise in FIG. 10A via the springs 692. Further, the press supporting members 68 rotate the sheet bundle holding arms 67 clockwise in FIG. 10A via the first torsion springs 671. By this, in the exemplary embodiment, first, the second opposing portion 672 of each sheet bundle holding arm 67 to contact the sheet bundle B. Then, the sheet bundle B is nipped and held by the first opposing portion 661 and the second opposing portions 672.

Thereafter, as shown in FIG. 10B, the first gears 62 are further rotated counterclockwise in FIG. 10B. This causes the press supporting members 68 to further move the second pressing roller 37B towards the first pressing roller 37A. As a result, the opposing surface 371 of the second pressing roller 37B opposes the fold of the sheet bundle B. That is, the fold of the sheet bundle B is nipped by the opposing surface 371 of the first pressing roller 37A and the opposing surface 371 of the second pressing roller 37B.

As shown in FIG. 11, the first gears 62 are further rotated counterclockwise in FIG. 11. This causes the cam surfaces 631 of the cams 63 to push the receiving portions 691 of the press arms 69. This causes the press arms 69 to send the press supporting members 68 via the springs 692. Then, the second pressing roller 37B presses the fold of the sheet bundle B.

Subsequent to the state in which the pressing roller unit 37 has nipped the fold, the movement of each press arm 69 is restricted. However, it is possible for the second gears 65 to continue rotating by twisting the second torsion springs 681. This makes it possible for the first rotary shaft 61 to also continue rotating. Therefore, the cams 63 are capable of pushing the receiving portions 691 by the continued rotation. In the exemplary embodiment, in this structure, a strong press force is provided by, for example, driving cams without transmitting the press force by using gears. In addition, in the exemplary embodiment, for example, a strong pressing operation is realized without using large strong gears.

Spring force that is generated by twisting the first torsion springs 671 acts so as to further increase holding force of the sheet bundle B by the sheet bundle holding arms 67.

### Description of Retreating Operation of Pressing Roller Unit

Next, the retreating operation of the pressing roller unit 37 is described.

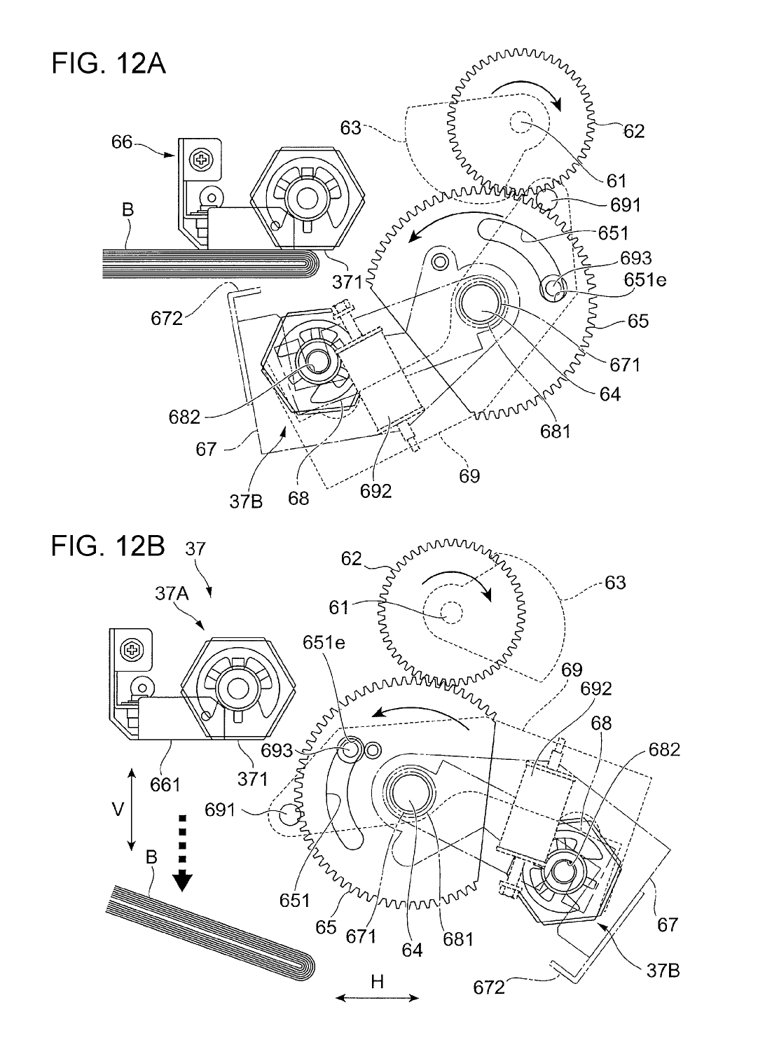

FIGS. 12A and 12B are each an explanatory view of the retreating operation of the pressing roller unit 37.

As shown in FIG. 12A, the second driving motor 37M2 (see FIG. 5) rotates the first gears 62 clockwise in FIG. 12A. This causes the second gears 65 to rotate the press arms 69 counterclockwise in FIG. 12A. The end portion 651e of the arc-shaped groove 651 of each second gear 65 contacts the protrusion 693 of its corresponding press arm 69.

Thereafter, as shown in FIG. 12B, the rotation of the second gears 65 causes the press arms 69 to rotate via the protrusions 693 caught by the arc-shaped grooves 651 of the second gears 65. The rotation of the press arms 69 causes the sheet bundle holding arms 67 and the press supporting members 68 to rotate. As a result, the second pressing roller 37B moves to a side opposite to the first pressing roller 37A with the second rotary shafts 64 being interposed therebetween. Accordingly, in the pressing roller unit 37 according to the exemplary embodiment, the second pressing roller 37B is swung with the second rotary shafts 64 serving as rotation centers and the press supporting members 68 principally serving as rotary arms. The second pressing roller 37B is swung such that it moves away from a location beneath the sheet bundle B, so that the sheet bundle B falls upon the sheet placement unit 45 by self weight thereof.

As described above, in the exemplary embodiment, dedicated transporting members for transporting a sheet bundle B whose fold has been pressed need not be provided downstream from the pressing roller unit 37 in the direction of transport of the sheet bundle B by the insertion rollers 36. Therefore, in the post-processing apparatus 2 according to the exemplary embodiment, the number of parts may be reduced.

### Pressing Roller Unit 37 According to First Modification

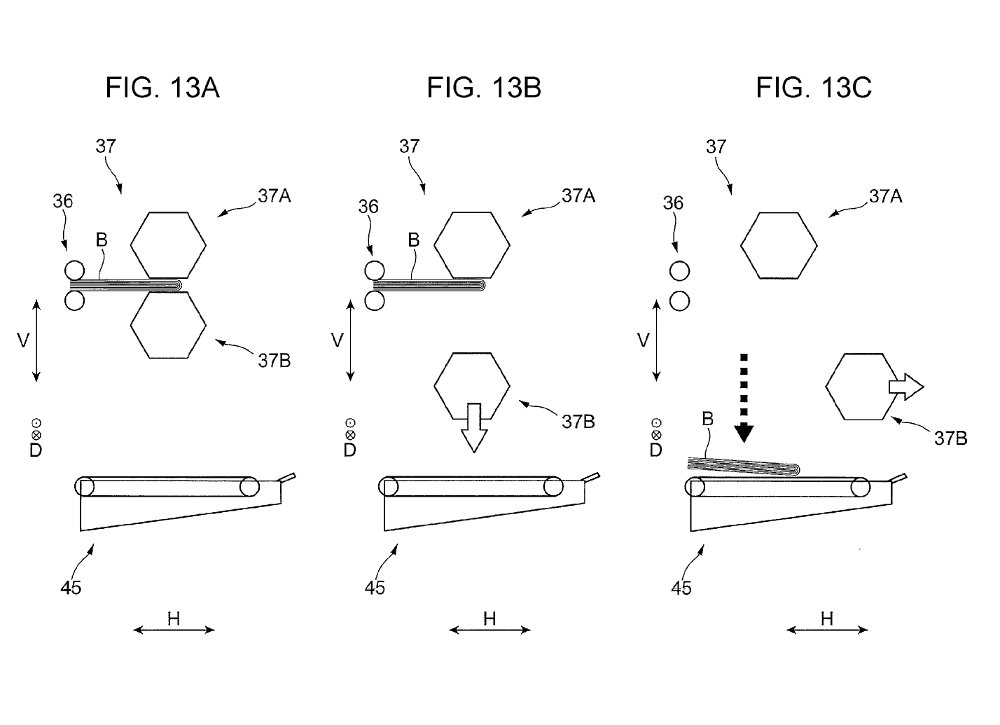

FIGS. 13A to 13C are each a conceptual view of a pressing roller unit 37 according to a first modification.

As shown in FIG. 13A, the pressing roller unit 37 according to the first modification is one in which a movement path of a second pressing roller 37B differs from that of the pressing roller unit 37 according to the above-described exemplary embodiment.

The second pressing roller 37B moves linearly away from the first pressing roller 37A in the up-down direction V, and linearly away from the first pressing roller 37A in the left-right direction H. More specifically, as shown in FIG. 13B, first, the second pressing roller 37B is moved downward in the up-down direction V. Then, as shown in FIG. 13C, the second pressing roller 37B is moved to a side opposite to the insertion rollers 36.

In the first modification, when moving the second pressing roller 37B in the up-down directions V, it is possible to use a pinion gear and a rack gear that are driven by a motor. Further, when the second pressing roller 37B is moved in the left-right direction H, it is possible to use a ball screw driven by a motor or a linear actuator.

In the pressing roller unit 37 according to the first modification, the second pressing roller 37B is moved away from the first pressing roller 37A in two stages by linearly moving the second pressing roller 37B in a first direction and by linearly moving the second pressing roller 37B in a second direction that differs from the first direction. As a result of the movements, the second pressing roller 37B moves away from a location beneath a sheet bundle B, so that the sheet bundle B whose fold has been pressed by the pressing roller unit 37 is caused to fall upon the sheet placement unit 45 by self weight thereof.

In the pressing roller unit 37 according to the first modification, there are two movement directions, so that it is possible to set a movement amount in each of the movement directions. Therefore, for example, in accordance with a layout with other members, it is possible to adjust a movement space of the second pressing roller 37B.

### Pressing Roller Unit 37 According to Second Modification

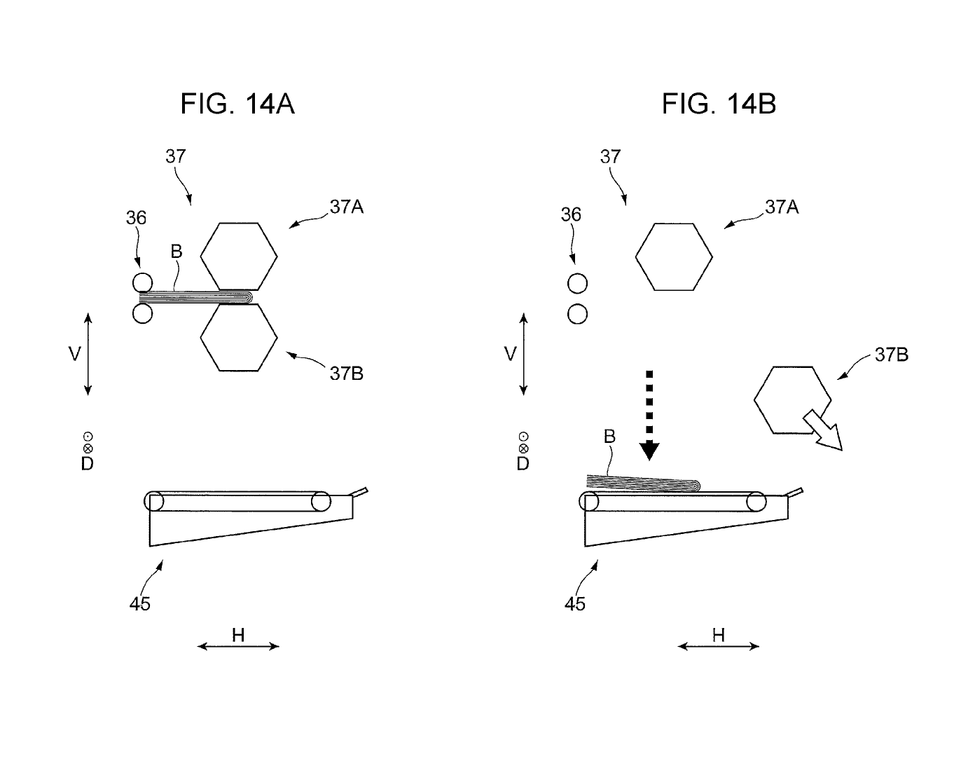

FIGS. 14A and 14B are each a conceptual view of a pressing roller unit 37 according to a second modification.

As shown in FIG. 14A, the pressing roller unit 37 according to the second modification is such that a movement path of a second pressing roller 37B differs from that of the pressing roller unit 37 according to the above-described exemplary embodiment.

The second pressing roller 37B moves away from a first pressing roller 37A in both the up-down direction V and the left-right direction H at the same time. More specifically, as shown in FIG. 14B, the second pressing roller 37B moves downward in the up-down direction V and obliquely towards a side opposite to the insertion rollers 36 in the left-right direction H.

In the second modification, when the second pressing roller 37B is obliquely moved, it is possible to use, for example, a pinion gear and a rack gear that are driven by a motor, a ball screw that is driven by a motor, or a linear actuator.

In the pressing roller unit 37 according to the second modification, by obliquely moving the second pressing roller 37B, the second pressing roller 37B is moved away from the first pressing roller 37A. As a result of the movement, the second pressing roller 37B moves away from a location beneath a sheet bundle B, so that the sheet bundle B whose fold has been pressed by the pressing roller unit 37 is caused to fall upon the sheet placement unit 45 by self weight thereof.

In the pressing roller unit 37 according to the second modification, since the number of movement directions of the second pressing roller 37B is one direction, the structure of the apparatus is simplified.

### Pressing Roller Unit 37 According to Third Modification

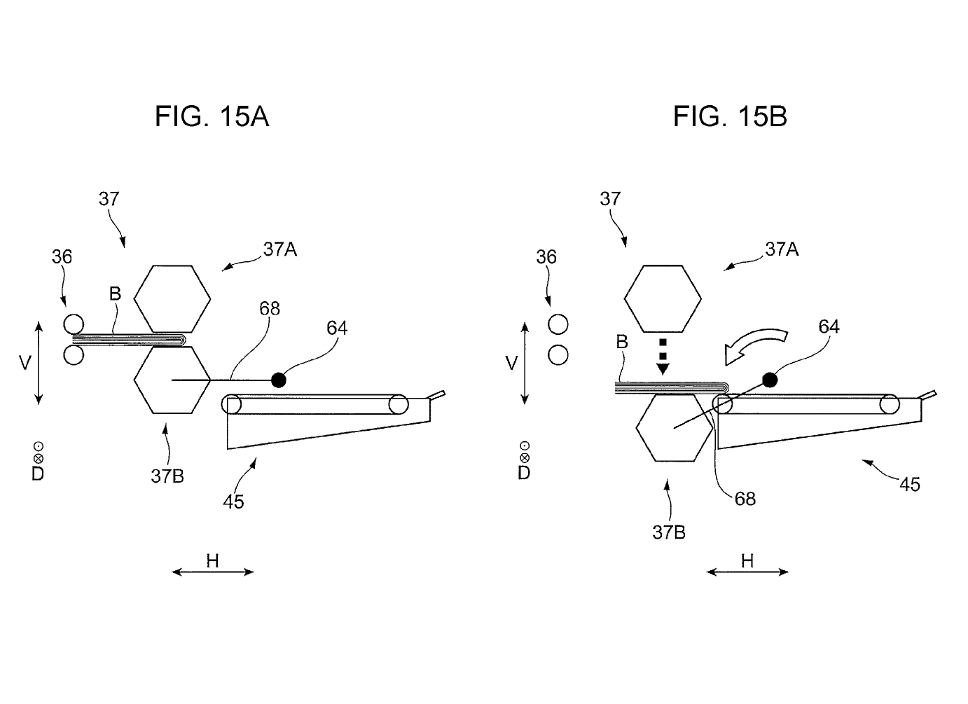

FIGS. 15A and 15B are each a conceptual view of a pressing roller unit 37 according to a third modification.

As shown in FIG. 15A, the pressing roller unit 37 according to the third modification is such that the positional relationship of the pressing roller unit 37 with respect to the sheet placement unit 45 differs from that in the pressing roller unit 37 according to the above-described exemplary embodiment. The basic structure of a mechanism of the pressing roller unit 37 is the same as that according to the above-described exemplary embodiment.

In the third modification, the sheet placement unit 45 is disposed below the pressing roller unit 37 in the up-down direction V and at a side opposite to the insertion rollers 36 in the left-right direction H. In the third modification, a second pressing roller 37B is formed so as to be movable to a location below the sheet placement unit 45 in the up-down direction V.

As shown in FIG. 15B, as in the exemplary embodiment, the pressing roller unit 37 according to the third modification is such that the position of the second pressing roller 37B is situated below an upper end portion of the sheet placement unit 45 (for example, the surface of the sheet placement unit 45 on which a sheet bundle B is placed), with the second rotary shafts 64 serving as rotation centers and the press supporting members 68 principally serving as rotary arms. As a result of the movement, the second pressing roller 37B moves away from a location beneath the sheet bundle B, so that the sheet bundle B whose fold has been pressed by the pressing roller unit 37 is caused to move to the sheet placement unit 45 by self weight thereof.

In the pressing roller unit 37 according to the third modification, since the second pressing roller 37B may be swung to a location below the upper end portion of the sheet placement unit 45, a movement region of the second pressing roller 37B becomes small. In addition, in the pressing roller unit 37 according to the third modification, for example, it is also possible to move the sheet bundle B to the sheet placement unit 45 while the sheet bundle B is placed on the upper side of the second pressing roller 37B. Therefore, damage following upon the movement of the sheet bundle B is suppressed.

### Pressing Roller Unit 37 According to Fourth Modification

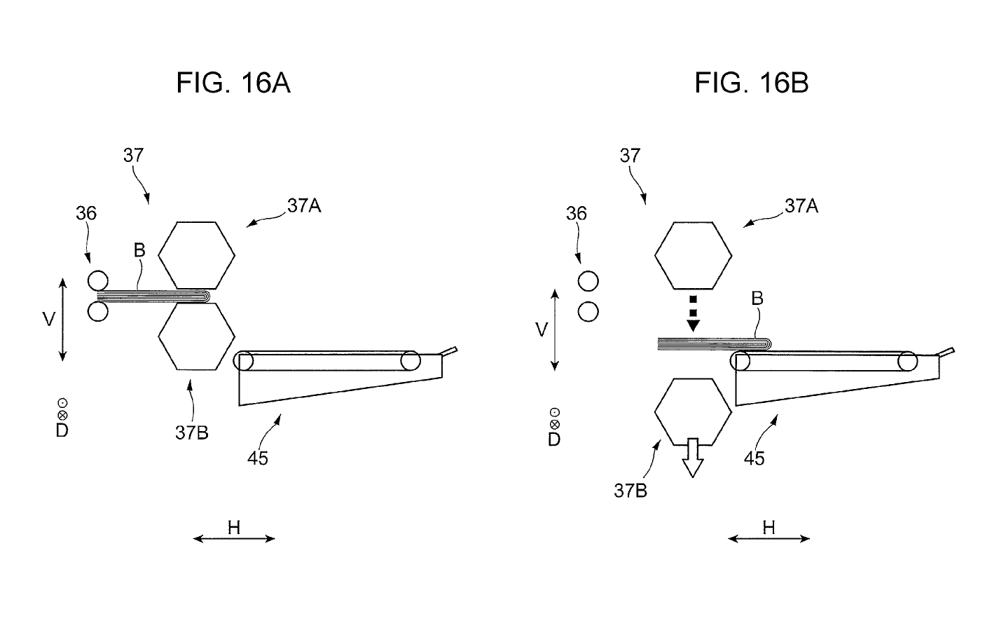

FIGS. 16A and 16B are each a conceptual view of a pressing roller unit 37 according to a fourth modification.

As shown in FIG. 16A, the pressing roller unit 37 according to the fourth modification is such that the positional relationship of the pressing roller unit 37 with respect to the sheet placement unit 45 differs from that in the pressing roller unit 37 according to the above-described exemplary embodiment. The pressing roller unit 37 according to the fourth modification is one in which a movement path of a second pressing roller 37B differs from that of the pressing roller unit 37 according to the above-described exemplary embodiment.

In the fourth modification, the sheet placement unit 45 is disposed below the pressing roller unit 37 in the up-down direction V and at a side opposite to the insertion rollers 36 in the left-right direction H. As shown in FIG. 16B, the second pressing roller 37B moves linearly downward away from a first pressing roller 37A in the up-down direction V. The second pressing roller 37B is formed as to be movable to a location below the sheet placement unit 45 in the up-down direction V.

In the fourth modification, when the second pressing roller 37B is moved, it is possible to use, for example, a pinion gear and a rack gear that are driven by a motor, a ball screw that is driven by a motor, or a linear actuator.

In the pressing roller unit 37 according to the fourth modification, the second pressing roller 37B is moved to a location below the upper end portion of the sheet placement unit 45. As a result of the movement, the second pressing roller 37B moves away from a location beneath a sheet bundle B, so that the sheet bundle B whose fold has been pressed by the pressing roller unit 37 is caused to move to the sheet placement unit 45 by self weight thereof.

In the pressing roller unit 37 according to the fourth modification, since the second pressing roller 37B may be linearly moved to a location below the sheet placement unit 45, a movement region of the second pressing roller 37B becomes small. In the pressing roller unit 37 according to the fourth modification, since the number of movement directions of the second pressing roller 37B is one direction, the structure of the apparatus is simplified. In addition, in the pressing roller unit 37 according to the fourth modification, for example, it is also possible to move the sheet bundle B to the sheet placement unit 45 while the sheet bundle B is placed on the upper side of the second pressing roller 37B. Therefore, damage following upon the movement of the sheet bundle B is suppressed.

### Pressing Roller Unit 37 According to Fifth Modification

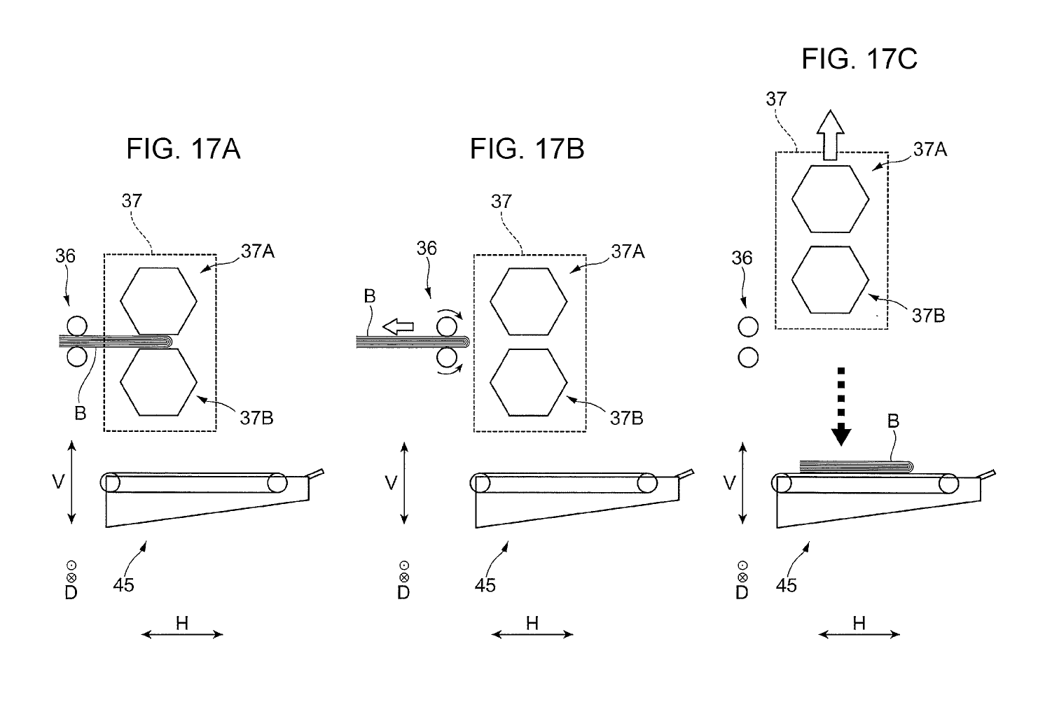

FIGS. 17A to 17C are each a conceptual view of a pressing roller unit 37 according to a fifth modification.

As shown in FIG. 17A, the pressing roller unit 37 according to the fifth modification differs from the pressing roller unit 37 according to the above-described exemplary embodiment in that the entire pressing roller unit 37 according to the fifth modification moves.

A first pressing roller 37A and a second pressing roller 37B move upward in the up-down direction V. The first pressing roller 37A and the second pressing roller 37B move linearly away from the sheet placement unit 45 in the up-down direction V.

In the fifth modification, when the second pressing roller 37B is moved, it is possible to use, for example, a pinion gear and a rack gear that are driven by a motor, a ball screw that is driven by a motor, or a linear actuator.

In the pressing roller unit 37 according to the fifth modification, as shown in FIG. 17B, after pressing a fold of a sheet bundle B, the insertion rollers 36 pull back the sheet bundle B towards a side opposite to the pressing roller unit 37. Thereafter, as shown in FIG. 17B, the pressing roller unit 37 moves upward in the up-down direction V. This causes the pressing roller unit 37 not to exist beneath the sheet bundle B. Then, as shown in FIG. 17C, for example, the insertion rollers 36 send the sheet bundle B. As a result, the sheet bundle B whose fold has been pressed by the pressing roller unit 37 falls upon the sheet placement unit 45 by self weight thereof.

In the pressing roller unit 37 according to the fifth modification, the degree of freedom in layout as regards the relative position between the pressing roller unit 37 and the sheet placement unit 45 is increased. In the pressing roller unit 37 according to the fifth modification, the falling height of the sheet bundle B is easily optimized, and the degree of booklet alignment performed on the sheet bundle B at the sheet placement unit 45 is increased.

### Pressing Roller Unit 37 According to Sixth Modification

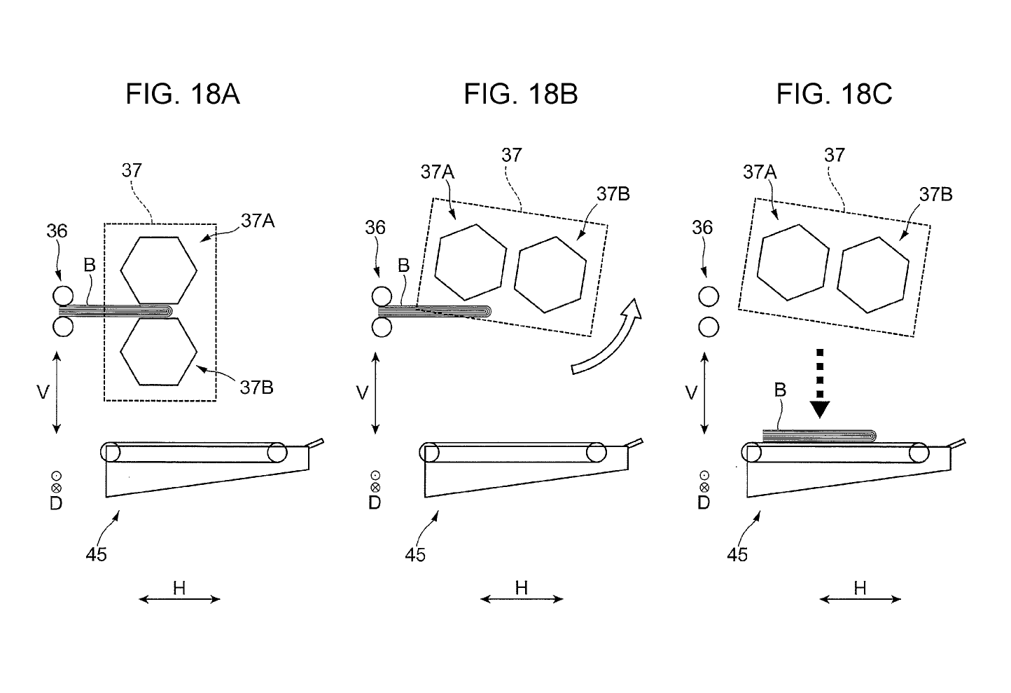

FIGS. 18A to 18C are each a conceptual view of a pressing roller unit 37 according to a sixth modification.

As shown in FIG. 18A, the pressing roller unit 37 according to the sixth modification differs from the pressing roller unit 37 according to the above-described exemplary embodiment in that the entire pressing roller unit 37 according to the sixth modification moves.

As shown in FIG. 18B, a first pressing roller 37A and a second pressing roller 37B are mounted on a rotary arm (not shown). The first pressing roller 37A and the second pressing roller 37B swing around the rotary arm serving as a rotary shaft.

In the sixth modification, when the second pressing roller 37B is moved, it is possible to use, for example, a rotary arm that is rotationally driven by a motor, a link mechanism that is driven by a linear actuator, or a link mechanism that is driven by a ball screw.

In the pressing roller unit 37 according to the sixth modification, after a fold of a sheet bundle B has been pressed, the first pressing roller 37A and the second pressing roller 37B are swung. At this time, the first pressing roller 37A and the second pressing roller 37B are moved away from the insertion rollers 36 and the sheet placement unit 45. As a result, the pressing roller unit 37 does not exist beneath the sheet bundle B, so that, as shown in FIG. 18C, the sheet bundle B whose fold has been pressed by the pressing roller unit 37 falls upon the sheet placement unit 45 by self weight thereof.

In the pressing roller unit 37 according to the sixth modification, by moving the first pressing roller 37A and the second pressing roller 37B themselves that have been nipping the sheet bundle B away from the sheet bundle B, the sheet bundle B is moved out of the pressing roller unit 37. Therefore, in the sixth modification, for example, the sheet bundle B is not moved by using the insertion rollers 36 as they are in the fifth modification.

As described above, in the pressing roller units 37 according to the exemplary embodiment and the modifications, either one of the first pressing roller 37A and the second pressing roller 37B, or both of the first roller member 37A and the second pressing roller 37B are moved in a direction (left-right direction H or up-down direction V) crossing (orthogonal to) a direction in which a fold of a sheet bundle B extends (front-back direction D). This causes the sheet bundle B to be placed in a state in which the sheet bundle B is capable of moving towards the sheet placement unit 45 by self weight thereof. In addition, for example, special transporting rollers for transporting the sheet bundle B whose fold has been pressed by discharging such a sheet bundle B from the pressing position 37U are not used.

In the exemplary embodiment and the modifications, the insertion rollers 36 are provided upstream from the pressing roller unit 37. Here, when at least one of the first pressing roller 37A and the second pressing roller 37B is moved and a sheet bundle B is caused to move to the sheet placement unit 45 by self weight thereof, the pressing roller unit 37 may be moved while the insertion rollers 36 are previously separated from the sheet bundle B, or the sheet bundle B may be made to fall after sending the sheet bundle B by the insertion rollers 36.

Further, for example, when transporting rollers or the like nip and transport a fold of a sheet bundle B that has been pressed and stitched by staples at a downstream side in the transport direction of the sheet bundle B, a load may be applied to the vicinity of the staples by the transporting rollers, as a result of which the sheet bundle B may be damaged, that is, may be creased, torn, or the like. In contrast, in the exemplary embodiment, since a sheet bundle B whose fold has been pressed is not transported by being nipped, it is possible to reduce damage to the sheet bundle B.

Although, in the above-described exemplary embodiment and the modifications, the first pressing roller 37A and the second pressing roller 37B are disposed side by side in the up-down direction, and a sheet bundle B is pressed while being provided along the left-right direction H, other modes are possible.

For example, a fold may be pressed while the sheet bundle B is obliquely provided with respect to the up-down direction or is provided along the up-down direction V. Even in such cases, the sheet bundle B may be caused to fall upon the sheet placement unit 45 by self weight thereof by moving either one of the first pressing roller 37A and the second pressing roller 37B.

Although, as described above, a fold of a sheet bundle B is pressed by using the first pressing roller 37A and the second pressing roller 37B, which are each a polygonal roller member having protrusions 37E, other modes are possible. For example, a fold may be pressed while a rotatable cross section of the first pressing roller 37A is caused to oppose a cylindrical roller member, or while the rotatable cross section of the first pressing roller 37A is caused to oppose a rectangular base that does not rotate. Further, the first pressing roller 37A and the second pressing roller 37B need not to have protrusions 37E.

The pressing roller unit 37 according to the exemplary embodiment may press a fold of a sheet bundle B by nipping the fold. A fold extending along the front-back direction D may be pressed by moving a pair of roller members in the left-right direction H or the front-back direction D with respect to such a fold. Even in this case, the sheet placement unit 45 may be disposed below the pair of roller members, and at least one of the two roller members may be moved, to move the sheet bundle B to the sheet placement unit 45 by self weight thereof.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A sheet processing device comprising:
a pressing unit configured to receive a sheet comprising a fold,
wherein the pressing unit comprises a first pressing member and a second pressing member,
wherein the first pressing member is configured to oppose and press the fold of the sheet,
wherein the second pressing member is configured to nip and press the fold, and
wherein the second pressing member is positioned opposite to the first pressing member;
a sheet placement unit that is provided below the pressing unit,
wherein the sheet placement unit is configured for the sheet to be placed on the sheet placement unit; and
a moving unit configured to move a position of at least one of the first pressing member and the second pressing member of the pressing unit,
wherein the moving the position of the at least one of the first pressing member and the second pressing member causes the sheet whose fold has been pressed by the pressing unit to move to the sheet placement unit by self weight of the sheet.

2. The sheet processing device according to claim 1, wherein at least one of the first pressing member and the second pressing member includes a plurality of opposing portions configured to oppose the fold,
wherein a respective one of the plurality of opposing portions that opposes the fold may be moved so that another opposing portion or another one of the plurality of opposing portions instead opposes the fold, by rotating the at least one of the first pressing member and the second pressing member,
wherein each one of the plurality of opposing portions includes protrusions, and
wherein arrangements of the protrusions of the plurality of opposing portions in an axial direction do not correspond with each other.

3. The sheet processing device according to claim 1, wherein the second pressing member is positioned below the sheet, and
wherein the moving unit is configured to move the second pressing member away from the first pressing member.

4. The sheet processing device according to claim 1, wherein the second pressing member is positioned below the sheet and presses the fold, and
wherein the moving unit moves the second pressing member to a location that is below an upper end portion of the sheet placement unit.

5. The sheet processing device according to claim 1, wherein the moving unit moves both the first pressing member and the second pressing member away from the fold.

6. An image forming system comprising:
an image forming apparatus configured to form an image on a sheet;
a folding mechanism configured to perform a folding process for forming a fold in the sheet on which the image has been formed by the image forming apparatus; and
a sheet processing device configured to move a position of at least one of a first pressing member and a second pressing member,
wherein the sheet processing device is configured to move a position of least one of the first pressing member and the second pressing member,
wherein the moving the position of the at least one of the first pressing member and the second pressing member causes the sheet whose fold has been pressed to move to a sheet placement unit by self weight of the sheet,
wherein the first pressing member is configured to oppose and press the fold of the sheet,
wherein the second pressing member is configured to nip and press the fold,
wherein the second pressing member is positioned opposite to the first pressing member,
wherein the sheet placement unit is provided below the first pressing member and the second pressing member, and
wherein the sheet placement unit is configured for the sheet to be placed on the sheet placement unit.

7. The image forming system according to claim 6, wherein an axial direction of each of the first pressing member and the second pressing member is provided along a direction in which the fold of the sheet extends, and
wherein at least one of the first pressing member and the second pressing member is configured to move in a direction that crosses the direction in which the fold extends.

8. The image forming system according to claim 6, wherein the sheet processing device includes a transporting member configured to transport the sheet on which the folding process has been performed by the folding mechanism and position the fold of the sheet at an opposing position where the first pressing member and the second pressing member oppose each other, and
wherein the transporting member is configured to cause the sheet to retreat from the opposing position before the position of the at least one of the first pressing member and the second pressing member is moved.

9. The sheet processing device according to claim 1, wherein the moving the position of the at least one of the first pressing member and the second pressing member causes the sheet whose fold has been pressed by the pressing unit to move to the sheet placement unit by self weight of the sheet alone.

10. The sheet processing device according to claim 1, wherein the moving the position of the at least one of the first pressing member and the second pressing member causes the sheet whose fold has been pressed by the pressing unit to move to the sheet placement unit without using any transporting rollers.

11. The sheet processing device according to claim 1, wherein the first pressing member is positioned above the second pressing member.

12. The sheet processing device according to claim 1, wherein the moving the position of the at least one of the first pressing member and the second pressing member causes the sheet whose fold has been pressed by the pressing unit to move to the sheet placement unit without any other forces being applied by the sheet processing device to move the sheet.
